(19) United States
(12) Patent Application Publication
(10) Pub. No.: US 2008/0303709 A1
(43) Pub. Date: Dec. 11, 2008

(54) Radar System For Monitoring Targets in Different Distance Ranges

(76) Inventors: Thomas Brosche, Stuttgart (DE); Sven Czarnecki, Ludwigsburg (DE)

Correspondence Address: KENYON & KENYON LLP, ONE BROADWAY, NEW YORK, NY, 10004, US

(21) Appl. No.: 11/794,282

(22) PCT Filed: Dec. 16, 2005
(86) PCT No.: PCT/EP05/56864

§ 371 Date: Apr. 3, 2008

(30) Foreign Application Priority Data
Dec. 23, 2004 (DE) 102004062023.7

(51) Int. Cl. G01S 13/66

(52) U.S. Cl. 342/28

(57) ABSTRACT

In a radar system for monitoring targets in different distance ranges, radar pulses are emitted whose length is greater than the length corresponding to the propagation time between two objects to be distinguished from one another, located at different distances. On the receive side the high-frequency signal supplied to the radar transmit pulse former and the radar receive signal are supplied to a mixer. The output signal of the mixer is supplied to a signal analyzer via at least one sampler, whose delay setting with respect to the rising edge of the radar transmit pulse predefines the limit of reach of the distance range to be monitored.

### BACKGROUND INFORMATION

Most radar-based burglar alarm systems used today essentially represent a simple CW (continuous wave) radar. According to this radar principle, the Doppler signal generated by the moving objects is analyzed and used as a criterion for an alarm. The distance range to be monitored is determined by the reach of the CW radar and may not be accurately set or adjusted, since the reach of the system is essentially limited by the transmission power, which cannot be determined with sufficient accuracy. In particular, targets having different radar back-scatter cross sections also have different reaches. In order to set and/or measure distances, other radar modulation methods must be used. It is generally known that distance may be measured using a pulse radar. A CW carrier signal is amplitude modulated in the form of pulses and emitted via an antenna. The carrier pulse is reflected on the target object and the distance of the target, as well as, using the Doppler effect, the relative velocity of the target object, may be determined from the time between the emission of the pulse and the arrival of the reflected beam.

A system based on this principle is described, in a modified form, in U.S. Pat. No. 6,239,736, where a burst oscillator is used, which emits pulses in a short sequence; the pulses are mixed with themselves or with the pulses generated subsequently in order to obtain target information about a distance range. Another method based on this principle according to German Patent Application No. DE 199 63 006 describes a variable virtual barrier generated at a certain distance from the sensor or having a certain length, the distance and velocity being measured simultaneously. German Patent Application No. DE 199 63 006 also proposes mixing the received pulses with reference pulses having an adjustable pulse duration which is different from that of the received pulse.

### SUMMARY OF THE INVENTION

Using the measures of the present invention, i.e.,
radar pulses are emitted whose length is greater than the length corresponding to the propagation time between two objects to be distinguished from one another, located at different distances or distance ranges;
on the receive side the high-frequency signal supplied to the radar transmit pulse former and the radar receive signal are supplied to a mixer;
the output signal of the mixer is supplied to a signal analyzer via at least one sampler, whose delay setting with respect to the rising edge of the radar transmit pulse predefines the limit of reach of the distance range to be monitored;
   the side lobes/side bands in the frequency spectrum fall more steeply, i.e., more rapidly, for a certain bandwidth. This is due to the relatively long radar pulses compared to the related art. The hardware complexity is low, since only a slight modification of a simple CW radar is necessary. The registration regulations for the authorized frequency ranges may thus be complied with without incurring high costs due to the advantageous spectral signal distribution (side lobe limitation). A simple and low-cost limitation of reach may be implemented for a mixed form of CW radar and pulse radar. There is the possibility of subdivision into different limits of reach for target object classification and differentiation. The current measuring range is not recognizable from the outside, which is advantageous for burglar alarm systems in particular.

If a target object moves into the monitoring range of the set limit of reach, a Doppler signal may be measured due to the movement of the target object in the radial direction with respect to the radar sensor.

### BRIEF DESCRIPTION OF THE DRAWINGS

FIG. 1 shows a block diagram of the radar system according to the present invention.

FIG. 2 shows a time diagram of the radar transmit pulse and the receive side sampling.

### DETAILED DESCRIPTION

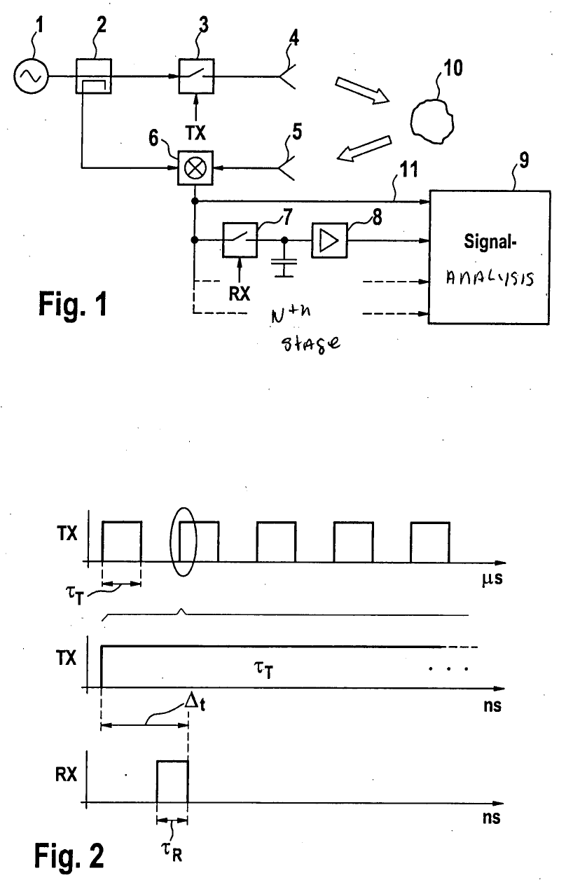

The construction of the radar system according to the present invention is shown in FIG. 1. Oscillator 1 generates a high-frequency signal, for example, in the GHz range, which is supplied to transmission antenna 4 via directional coupler 2 and HF switch 3 (radar transmit pulse former) and is emitted therefrom. Part of the transmission power of oscillator 1 is extracted at directional coupler 2 and supplied to receive mixer 6. The electromagnetic wave reflected by target object 10 is supplied to receive mixer 6 via receive antenna 5. In the case of a moving target object 10, a low-frequency Doppler signal, whose frequency is proportional to the relative velocity between the radar sensor and the target object, is output by receive mixer 6. The mixer output signal passes through LF switch 7, which functions as a sampler and is part of sample-and-hold stage 8. A plurality of receive channels may be combined in signal analyzer 9 for signal analysis. In addition, the output signal of mixer 6 may also be supplied directly (without switch 7 and the sample-and-hold stage) to signal analyzer 9.

In order to implement a radar system having reach limitation, in which the side lobes/side bands in the frequency spectrum fall rapidly, a circuit control like the one depicted in FIG. 2 is used. The top and central part (zoomed) of FIG. 2 show the modulation of the transmit signal. The bottom part of FIG. 2 shows the circuit control in the receive branch, also in a zoomed view. The radar pulses are 10 μs long, for example, for a period length of 25 μs. HF switch 3 is activated by control signal TX in such a way that a transmit pulse having a relatively long pulse length T_{T} in the μs range, for example, and steep edges is emitted. Using a long pulse in the transmit signal, the desired transmit signal spectrum having rapidly falling side bands is obtained.

Limit of reach R of the system (set delay) over time Δₜ from the rising edge of the TX pulse to the falling edge of the RX pulse is set using LF switch 7. The set reach R of the monitoring area may be calculated using the formula known in radar technology

R=c·Δt/2

where c is the velocity of light in the corresponding medium. For the pulse/sample length T_{R} of LF switch 7 the following formula applies:

T_{R}=T_{T}.

In the example shown in FIG. 2, it is limited to a value T_{R}<T_{T}. The receive power of the signal back-scattered on the particular target thus remains approximately constant within the monitored distance range, and the most abrupt possible transition to the non-visible range is obtained for the preset reach R. A plurality of distance zones may thus be simultaneously monitored. The pulse/sample length T_{R} of LF switch 7 may, however, also be equal to time Δt. At the same time, the mixer output signal may be directly (11) used for signal analysis 9, whose reach is not additionally limited and thus represents the maximum reach according to the above-mentioned radar equation. Sample pulse RX (T_{R}) delayed with respect to transmit pulse TX monitors the entire measuring range from zero distance to the set limit of reach R for each delay setting (Δt−_{T}_{_{R}}). Values in the nanosecond range are selected for sample pulse RX.

A plurality of samplers connected in parallel may be provided, whose delay setting and sampling times are selected in such a way that they are operable in a non-overlapping temporally staggered manner during the transmission of a radar pulse. Targets in a plurality of distance ranges (zones) may thus be monitored.

In the set monitoring range the system essentially behaves like a CW radar and delivers the Doppler signal of a moving target object. By comparing a plurality of distance ranges, a plurality of targets may be better discriminated and possibly classified. Since short limits of reach (R<1 m) may also be set using this system, sabotage protection (antimask) for unauthorized attempts at masking or covering the system may also be implemented.

1-8. (canceled)

9. A radar system for monitoring targets in different distance ranges, in which radar pulses are emitted whose length is greater than a length corresponding to a propagation time between two objects to be distinguished from one another, situated at different distances or in different distance ranges, the radar system comprising:
a radar transmit pulse former for receiving a high-frequency signal, on a receive side;
a mixer for receiving the high-frequency signal and a radar receive signal;
at least one sampler, whose delay setting with respect to a rising edge of a radar transmit pulse predefines a limit of reach of a distance range to be monitored; and
a signal analyzer for receiving an output signal of the mixer via the at least one sampler.

10. The radar system according to claim 9, wherein the output signal of the mixer is supplied to the signal analyzer via a plurality of samplers connected in parallel, each sampler having a different delay setting for a different limit of reach.

11. The radar system according to claim 9, wherein a direct connection is provided between the mixer and the signal analyzer in parallel to the at least one sampler.

12. The radar system according to claim 9, wherein the sampler includes a switch having a following sample-and-hold element.

13. The radar system according to claim 9, wherein the signal analyzer analyzes a Doppler signal of at least one moving target object.

14. The radar system according to claim 9, wherein the delay setting of the at least one sampler and a sampling time are selected in such a way that a sampling takes place still during an emission of a radar pulse.

15. The radar system according to claim 10, wherein the plurality of samplers have delay settings and sampling times selected in such a way that they are operable during an emission of a radar pulse in a non-overlapping temporally staggered manner.

16. The radar system according to claim 9, wherein, via a comparison within a plurality of distance ranges, a discrimination of objects for multitarget scenarios is performed and a target object classification.
